(19) United States
(12) Patent Application Publication
(10) Pub. No.: US 2026/0055844 A1
(43) Pub. Date: Feb. 26, 2026

(54) MAGNETIC QUICK-RELEASE BLUETOOTH SPEAKER RIDING MOUNT

(71) Applicant: Pak Hei Wong, Dongguan (CN)

(72) Inventor: Pak Hei Wong, Dongguan (CN)

(21) Appl. No.: 19/301,895

(22) Filed: Aug. 15, 2025

(30) Foreign Application Priority Data
Aug. 22, 2024 (CN) 202422038770.7

(51) Int. Cl. F16M 13/02; B62J 45/10

(52) U.S. Cl. CPC F16M 13/02; B62J 45/10

(57) ABSTRACT

A magnetic quick-release Bluetooth speaker riding mount includes a connecting portion configured to connect and secure a Bluetooth speaker, and a fixing portion configured to secure the connecting portion to a riding vehicle. The fixing portion is provided with a built-in magnet for magnetic attachment to the riding vehicle. The riding mount adopts a magnetic attachment method in place of traditional mechanical fastening methods, thereby greatly simplifying the installation and removal of a speaker. A user simply brings the speaker close to a mounting position, and a magnetic attachment device will automatically secure the speaker to the riding vehicle. The entire process requires no tools, making the process simple and quick. This design not only improves the user experience, but also solves the problem of equipment wear and tear caused by mechanical fastening, thereby extending the service life of both the speaker and the riding vehicle.

### CROSS-REFERENCE TO RELATED APPLICATIONS

This application claims priority to Chinese Patent Application No. 202422038770.7, filed on Aug. 22, 2024, which is hereby incorporated by reference in its entirety.

### TECHNICAL FIELD

The present disclosure relates to the field of riding mounts, and in particular to a magnetic quick-release Bluetooth speaker riding mount.

### BACKGROUND

At present, Bluetooth speakers have become convenient devices widely used in daily life, especially during riding activities. They not only provide music entertainment for riders but also offer a voice navigation function, significantly improving the overall riding experience. However, most existing Bluetooth speaker riding mounts adopt mechanical fastening methods, such as using screws, fasteners, or straps to secure the speakers to handlebars, frames, or seat posts of the bicycles. Although the mechanical fastening methods can maintain the stability of the speakers during riding, and prevent them from falling off due to vibration or bumps, they also have some obvious drawbacks.

First, mechanical fastening methods are relatively cumbersome in installation and removal, usually requiring the use of tools such as screwdrivers or wrenches, and users need to spend some time and effort to complete the process. For the users who need to frequently remove and install the speakers, especially during short stops or in emergency situations, the complexity of mechanical fastening methods makes removal operations very inconvenient. For example, when a user encounters sudden weather changes, such as heavy rain or strong wind, during outdoor riding, he/she may need to quickly remove the speaker to avoid damage. However, the mechanical fastening methods require an extended period of time to remove due to their strong tightening force, making them difficult to respond quickly to emergencies. In addition, since mechanical fastening methods usually involve direct contact between metal components and the surface of the bicycle or the speaker, long-term use may cause wear and tear on the surfaces of the bicycle or the speaker, thereby affecting the appearance and service life of the devices. Especially for some high-end bicycles and speakers, the wear and tear not only detracts from the aesthetic value but may also impair the functionality of the devices.

Second, mechanical fastening methods lack flexibility, making them difficult to meet different riders'needs for personalized positioning of the speakers. Existing fastening methods generally only allow the speaker to be mounted at specific positions on the handlebars, frames, or seat posts of the bicycles, making them almost impossible for the user to adjust the speaker position according to actual needs. For example, in different riding scenarios, a user may wish to adjust the speaker to a position closer to his/her ears for better sound quality, or relocate the speaker to a safer position to avoid obstructing the rider's line of sight. However, the limitations of existing fastening methods make the adjustments nearly impossible, thereby affecting riding comfort and safety.

These shortcomings mainly arise from the fact that traditional mechanical fastening methods overly focus on fastening strength and stability while neglecting ease of installation, device protection, and the realization of user-specific needs. The design philosophy may have made sense in early market demands, however, as the user needs have become increasingly diverse, traditional mechanical fastening methods are becoming increasingly unsuitable for modern users. The user not only expects the speaker to be firmly fixed on the bicycle, but also hopes to install and remove the speaker easily in various usage scenarios, minimize equipment wear and tear, and flexibly adjust the speaker's position according to personal preferences.

### SUMMARY

The present disclosure is intended to overcome at least one deficiency in the prior art and to provide a magnetic quick-release Bluetooth speaker riding mount. The riding mount adopts a magnetic attachment method in place of traditional mechanical fastening methods, thereby greatly simplifying the installation and removal of a speaker. A user simply brings the speaker close to a mounting position of the riding mount, and a magnetic attachment device will automatically secure the speaker to a riding vehicle. The entire process requires no tools, making the process simple and quick. This design not only improves the user experience, but also solves the problem of equipment wear and tear caused by mechanical fastening, thereby extending the service life of both the speaker and the riding vehicle.

To achieve the above objectives, the present disclosure provides a magnetic quick-release Bluetooth speaker riding mount. The riding mount includes a connecting portion configured to connect and secure a Bluetooth speaker, and a fixing portion configured to secure the connecting portion to the riding vehicle. The fixing portion is provided with a built-in magnet for magnetic attachment to the riding vehicle.

In some embodiments, the connecting portion and the fixing portion are integrally formed.

In some embodiments, the connecting portion is internally provided with a second magnet having magnetic poles oriented opposite to those of the magnet in the fixing portion. The magnetic attachment between the magnet and the second magnet enables a detachable connection between the fixing portion and the connecting portion.

In some embodiments, the connecting portion and the fixing portion are detachably connected via a snap-fit structure.

In some embodiments, an arc-shaped mating groove is formed on the fixing portion.

In some embodiments, the arc-shaped mating groove is formed on the fixing portion, and an inner side of the mating groove is provided with an anti-slip layer.

In some embodiments, the arc-shaped mating groove is formed on the fixing portion, and an inner side surface of the mating groove is processed into a toothed surface.

In some embodiments, the fixing portion includes a flexible strap and a mounting platform disposed on the flexible strap for connection with the connecting portion. Two ends of the flexible strap are provided with magnetic buckles. When in use, the flexible strap is wrapped around and then secured by the magnetic buckles to form an annular fixing structure.

In some embodiments, the connecting portion is an elastic clamp.

In some embodiments, the connecting portion is a soft sleeve adapted to fit the Bluetooth speaker.

Compared with the prior art, the present disclosure has at least one of the following beneficial effects:
1. Easy installation and removal: A built-in magnet in the fixing portion allows for quick magnetic attachment between the mount and the riding vehicle, simplifying the installation and removal process without tools, which improves convenience and efficiency, especially for a user who needs to frequently install and remove the speaker.
2. High flexibility: the connecting portion and the fixing portion can be detachably connected via a magnetic attachment structure or a snap-fit structure. The user can freely choose and adjust a position of the speaker according to actual needs, thereby improving flexibility in use.
3. Enhanced stability and anti-slip performance: The arc-shaped mating groove design of the fixing portion, particularly an anti-slip layer or a toothed surface is formed on the inner surface, which enhances the stability of the mount on the riding vehicle and effectively prevents the speaker from sliding or detaching due to vibration or bump during riding.

The advantageous effects described above are not exhaustive. Other potential advantages and detailed technical implementations will be further disclosed in the embodiments or other parts of the present disclosure.

### BRIEF DESCRIPTION OF DRAWINGS

Various aspects of the present disclosure will be better understood by reading the following detailed description in conjunction with the accompanying drawings. It should be noted that the positions, dimensions, and ranges of various structures shown in the drawings are not necessarily represent their actual positions, dimensions, and ranges. In the accompanying drawings:

FIG. 1 is a schematic structural diagram according to Embodiment 1 of the present disclosure.

FIG. 2 is a schematic structural diagram according to Embodiment 1 of the present disclosure from another perspective, where a connecting portion is engaged with a Bluetooth speaker.

FIG. 3 is a schematic structural diagram according to Embodiment 1 of the present disclosure, where a connecting portion and a fixing portion are in a separated state.

FIG. 4 is a schematic diagram according to Embodiment 1 of the present disclosure in a usage state mounted on a riding vehicle.

FIG. 5 is a schematic structural diagram according to Embodiment 2 of the present disclosure.

FIG. 6 is a schematic structural diagram according to Embodiment 3 of the present disclosure.

FIG. 7 is a schematic structural diagram according to Embodiment 3 of the present disclosure from another perspective.

FIG. 8 is a schematic structural diagram according to Embodiment 4 of the present disclosure.

FIG. 9 is a schematic structural diagram according to Embodiment 4 of the present disclosure from another perspective.

FIG. 10 is a schematic diagram according to Embodiment 4 of the present disclosure in a usage state mounted on a riding vehicle.

FIG. 11 is a schematic structural diagram of one fixing portion.

FIG. 12 is a schematic structural diagram of another fixing portion.

FIG. 13 is a schematic structural diagram of a sleeve-type connecting portion.

FIG. 14 is a schematic structural diagram of a sleeve-type connecting portion adapted to a Bluetooth speaker.

### DESCRIPTION OF EMBODIMENTS

The present disclosure will now be described with reference to the accompanying drawings, in which several embodiments of the present disclosure are illustrated. However, it should be understood that the present disclosure may be presented in many different forms and is not to be limited to the embodiments described below. In fact, the embodiments described below are provided to make the present disclosure more complete and to fully illustrate the scope of protection of the present disclosure to those skilled in the art. It should further be understood that the embodiments disclosed herein may be combined in various ways to provide more additional embodiments.

It should be understood that, throughout all of the drawings, identical reference numerals refer to the same elements. In the drawings, some features may be distorted for clarity of illustration.

It should be understood that the terms used in the specification is intended only to describe particular embodiments and are not intended to limit the present disclosure. All terms used in the specification (including technical and scientific terms) have the meanings as commonly understood by those ordinary skill in the art to which the present disclosure belongs, unless otherwise defined. For the sake of brevity and/or clarity, techniques, methods, and devices known to those of ordinary skill in the art may not be described in detail herein, but should be considered part of the authorized specification.

As used in the specification, the singular forms “a/an,” “the”, and “said” include the plural forms as well. As used herein, the terms “include/comprise,” “including/comprising,” “contain” specify the presence of stated features, but do not preclude the presence of one or more additional features. The term “and/or” as used in the specification includes any and all combinations of the associated listed items.

### Embodiment 1

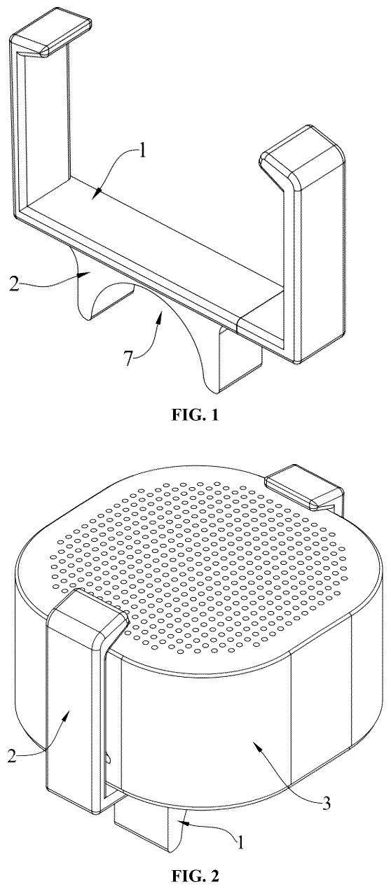

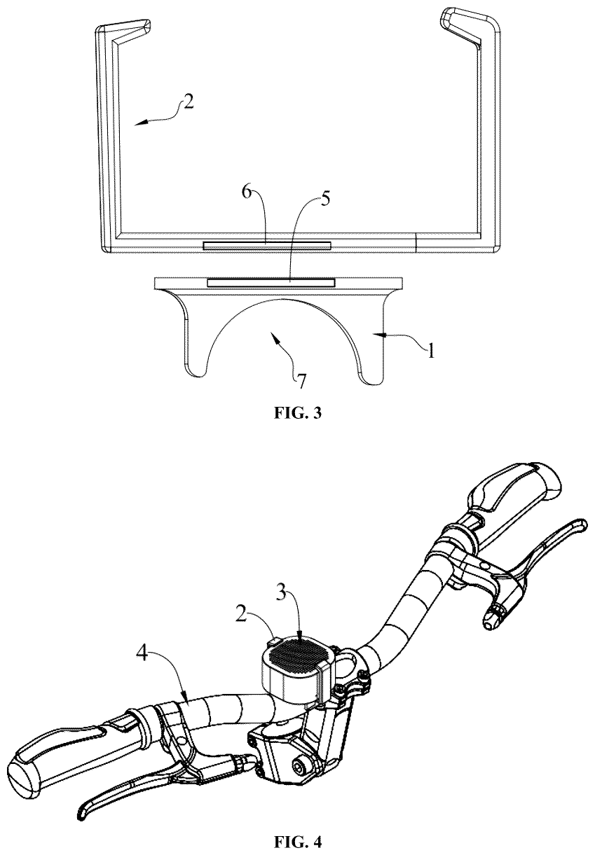

As shown in FIGS. 1-4, this embodiment provides a magnetic quick-release Bluetooth speaker riding mount, which is intended to offer a convenient, secure, and flexible speaker mounting solution to meet the needs of riders in various riding scenarios. An overall structure of the riding mount includes a connecting portion 1 and a fixing portion 2. The connecting portion 1 is configured to connect to and secure a Bluetooth speaker 3, and the fixing portion 2 is configured to securely attach the connecting portion 1 and the Bluetooth speaker 3 connected by the connecting portion to a riding vehicle 4.

In terms of a specific structure, the fixing portion 2 is designed with a built-in magnet 5. The magnet 5 is made of a high-strength magnetic material, such as neodymium-iron-boron magnet. Strong magnetic force of the magnet ensures that when the mount comes into contact with a ferromagnetic metal component of the riding vehicle 4 (such as a handlebar), it can be quickly and firmly adsorbed, thereby achieving a stable mounting effect. In a practical scenario, when a rider needs to mount the Bluetooth speaker, the fixing portion 2 having the magnet 5 is simply brought close to the handlebar or a frame of the riding vehicle 4, the magnet 5 will automatically attach, completing the mounting of the Bluetooth speaker 3. This design not only eliminates the need for tools but also significantly improves installation speed and convenience.

To further illustrate this embodiment, the connecting portion 1 is designed as an elastic clamp structure, which has a fixed end and a movable end having an elastic restoring function. The fixed end and the movable end of the elastic clamp cooperate to form a clamping area that conforms to a shape of the Bluetooth speaker 3, ensuring that the Bluetooth speaker 3 can be securely fixed to the connecting portion 1.

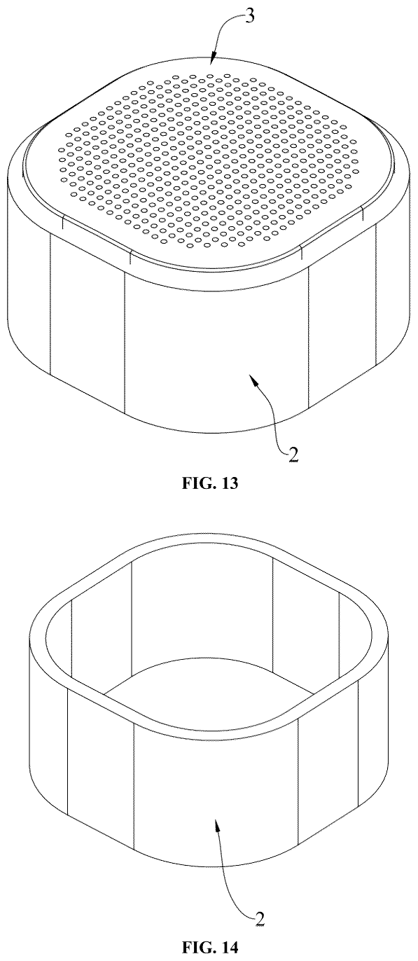

As an alternative technical option, as shown in FIGS. 13 and 14, the fixing portion 2 may also be configured as a soft sleeve adapted to fit the Bluetooth speaker 3. The soft sleeve is made of a highly elastic material, such as silicone or polymer, and is capable of tightly enveloping the Bluetooth speaker 3, ensuring that the Bluetooth speaker 3 does not become loose due to vibration or bumps during use. This soft sleeve design not only provides good protective performance but also accommodates the Bluetooth speakers 3 of varying models and sizes, thereby enhancing the universality and adaptability of the mount. By combining the soft sleeve and the Bluetooth speaker 3, the mount allows for secure attachment of the speaker to the riding vehicle, ensuring safety and stability of the Bluetooth speaker 3 during riding.

In this embodiment, the connecting portion 1 and the fixing portion 2 achieve quick connection and mating through a magnetic attachment structure, and the Bluetooth speaker 3 is fixed to the riding vehicle through the magnetic attachment between the connecting portion 1 and the fixing portion 2.

Specifically, in order to achieve the magnetic attachment structure, in this embodiment, the connecting portion 1 is internally provided with a second magnet 6 having magnetic poles oriented opposite to those of the magnet 5 in the fixing portion 2. The second magnet 6 is configured to cooperate with the magnet 5 of the fixing portion 2, and make use of magnetic attachment to realize secure connection between the connecting portion 1 and the fixing portion 2, while allowing for detachable operation between them.

More specifically, the second magnet 6 is disposed at a bottom of the connecting portion 1, and is made of the same or similar high-strength magnetic material, such as neodymium-iron-boron magnet, as the magnet 5 in the fixing portion 2. This material has extremely strong magnetic properties, thereby ensuring that when the connecting portion 1 and the fixing portion 2 are brought close together, strong magnetic force is generated between the magnet 5 and the second magnet 6, thereby automatically aligning and attaching the connecting portion 1 to the fixing portion 2. Through the magnetic attachment, a secure connection is formed between the connecting portion 1 and the fixing portion 2, effectively preventing loosening or displacement during riding. In addition, the magnetic connection offers a degree of detachability. When the user needs to remove the connection, appropriate external force may be applied to easily separate the connecting portion 1 from the fixing portion 2. This design greatly improves the ease of use of the mount, allowing the user to quickly install or remove the Bluetooth speaker 3 without the need for any tools.

In this embodiment, in order to further improve installation stability, an arc-shaped mating groove 7 formed at a bottom of the fixing portion 2. The arc-shaped mating groove 7 is designed to improve the fit between the fixing portion 2 and a curved surface of the riding vehicle to which it is attached, thereby further improving the stability of connection.

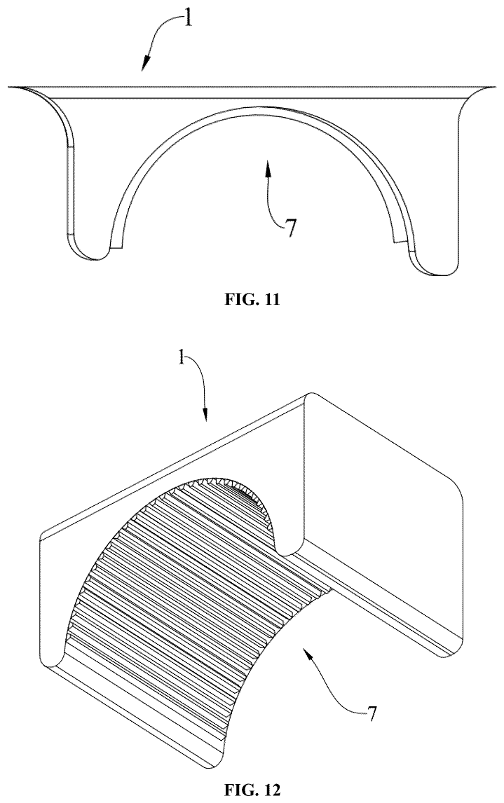

Further, as an application option, as shown in FIGS. 11 and 12, the arc-shaped mating groove 7 of the fixing portion 2 is designed to provide two different options to improve the fixing effect and to accommodate different usage requirements. These two designs are an anti-slip layer and a toothed surface, and the user may select one of them according to the actual situation.

As shown in FIG. 11, in the first design, an inner side of the arc-shaped mating groove 7 is covered with the anti-slip layer. The anti-slip layer is made of a material having a high coefficient of friction, such as rubber or polyurethane. When the fixing portion 2 made of the material is in contact with a surface of the riding vehicle, large friction force may be generated to prevent displacement caused by vibration or external force. The application of the anti-slip layer ensures that the mount can remain stable under various road conditions, and also helps protect a frame surface of the riding vehicle to avoid wear or scratches.

As shown in FIG. 12, in the second design, an inner side surface of the arc-shaped mating groove 7 is processed into a toothed surface. The toothed surface is formed by a plurality of tiny tooth-like protrusions, which may be embedded into the grooves on the surface of the riding vehicle frame when the mount is in contact with the riding vehicle frame, thereby providing additional grip. The toothed-shaped design is particularly suitable for use on bumpy roads or during intense exercise, effectively preventing the mount from slipping and ensuring that the Bluetooth speaker 3 remains stable during riding.

In summary, this embodiment enables rapid installation and removal of the Bluetooth speaker in various riding environments while maintaining a high degree of flexibility and ease of operation. The mount not only effectively overcomes the shortcomings of traditional mechanical fastening methods, but also further improves the safety and durability of the device through reasonable material selection and structural design. Combined with actual usage scenarios, the technical solution demonstrates significant advantages in various outdoor riding activities, providing the rider with superior user experience.

### Embodiment 2

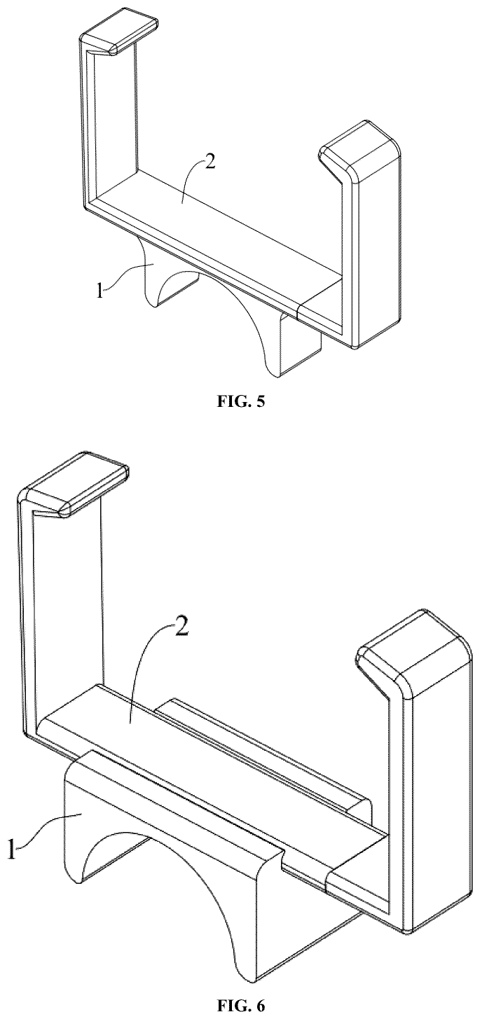

As shown in FIG. 5, the differences between this embodiment and Embodiment 1 lie in that the design of the magnetic quick-release Bluetooth speaker riding mount adopts an integrally formed structure, that is, the connecting portion 1 and the fixing portion 2 are formed using a one-piece molding process, thereby ensuring the overall stability and durability of the mount.

It should be understood that, due to the integrated structure design, it is unnecessary to dispose the second magnet 6 in the connecting portion 1.

This one-piece molding design greatly simplifies the structure of the mount, reduces possible points of failure, and improves the overall durability and stability of the mount. The elastic material of the elastic clamp also has good cushioning properties, which can absorb vibrations generated during riding and protect the Bluetooth speaker 3 from damage.

### Embodiment 3

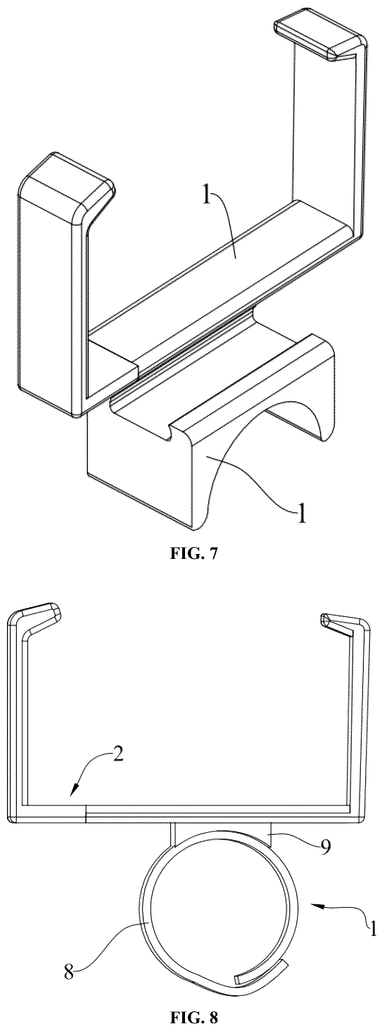

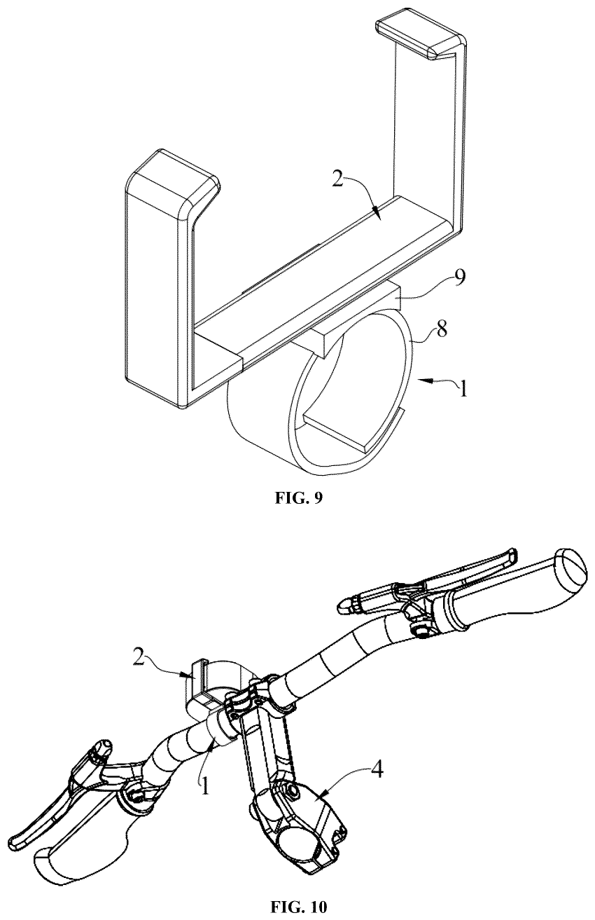

As shown in FIGS. 6 and 7, the differences between this embodiment and Embodiment 1 lie in that the design of the magnetic quick-release Bluetooth speaker riding mount adopts a snap-fit structure to achieve a detachable mating connection between the connecting portion 1 and the fixing portion 2. The snap-fit structure is composed of a snap-fit slot and a snap-fit hook, and is designed as a continuous structure, such that the connecting portion 1 and the fixing portion 2 form a firm connection when assembled, and may be separated without the need for an additional release button.

Specifically, when the user aligns and presses the connecting portion 1 with the fixing portion 2, the snap-fit hook on the connecting portion 1 is sequentially inserted into the snap-fit slot on the fixing portion 2 to form a continuous mechanical lock. This snap-fit connection method utilizes the elastic deformation properties of the material to ensure smooth insertion and locking during connection, and also allows the connecting portion to be separated from the fixing portion by applying appropriate pulling force when disassembly is needed.

### Embodiment 4

As shown in FIG. 8, compared with Embodiment 1, the design of the magnetic quick-release Bluetooth speaker riding mount in this embodiment is specifically designed for a riding vehicle made of a non-ferromagnetic material, such as aluminum alloy and carbon fiber frame. To meet the requirements, the connecting portion 1 adopts a combined structure of a flexible strap 8 and a mounting platform 9. This design not only ensures that the mount can be securely installed on the riding vehicle frame made of the special material, but also provides excellent flexibility of use and ease of installation.

Specifically, the flexible strap 8 is made of high-quality silicone, which has excellent elasticity and flexibility. The silicone strap can closely conform to riding vehicle frames of various shapes and sizes, especially those made of a non-ferromagnetic material such as aluminum alloy and carbon fiber. The high wear resistance and aging resistance of the silicone strap ensure long-term reliability, preventing the silicone strap from losing elasticity or damage even after frequent use.

The mounting platform 9 is disposed at a middle portion of the flexible strap 8 for securely connecting to the connecting portion 1.

The mounting platform 9 is connected to the connecting portion 1 through magnetic attachment or a snap-fit structure.

In practical application, the mounting platform 9 may also be formed integrally with the connecting portion 1, such that the connecting portion 1 and the fixing portion 2 form an integral structure.

When in use, the flexible strap 8 is secured by magnetic buckles at both ends. The magnetic buckles are made of a strong magnetic material, ensuring that the silicone strap can quickly wrap around and form an annular structure, thereby firmly securing the mount to the riding vehicle frame. Since the non-ferromagnetic material such as aluminum alloy and carbon fiber cannot be directly secured by magnetic force, the annular structure of the flexible strap 8 and the user of the magnetic buckles provide additional holding force, ensuring that the mount will not loosen or slip during riding.

In summary, through the use of the flexible strap 8 and the magnetic buckles, the magnetic quick-release Bluetooth speaker riding mount in this embodiment is particularly suitable for the riding vehicle made of a non-ferromagnetic material, such as aluminum alloy and carbon fiber frame. This design not only overcomes the limitations of conventional magnetic attachment methods, but also provides a high degree of installation flexibility and stability, offering the rider a reliable speaker-mounting solution under various riding conditions.

Although exemplary embodiments of the present disclosure have been described above, those skilled in the art will appreciate that various modifications and changes can be made to the exemplary embodiments without departing from the spirit and scope of the present disclosure. Therefore, all such modifications and changes are intended to be included within the scope of protection of the present disclosure. The present disclosure is defined by the appended claims, and the equivalents of the claims are intended to be included therein.

What is claimed is:

1. A magnetic quick-release Bluetooth speaker riding mount, comprising a connecting portion configured to connect and secure a Bluetooth speaker, and a fixing portion configured to secure the connecting portion to a riding vehicle, where the fixing portion is provided with a built-in magnet for magnetic attachment to the riding vehicle.

2. The magnetic quick-release Bluetooth speaker riding mount according to claim 1, wherein the connecting portion and the fixing portion are integrally formed.

3. The magnetic quick-release Bluetooth speaker riding mount according to claim 1, wherein the connecting portion is internally provided with a second magnet having magnetic poles oriented opposite to those of the magnet in the fixing portion; and magnetic attachment between the magnet and the second magnet enables a detachable connection between the fixing portion and the connecting portion.

4. The magnetic quick-release Bluetooth speaker riding mount according to claim 1, wherein the connecting portion and the fixing portion are detachably connected via a snap-fit structure.

5. The magnetic quick-release Bluetooth speaker riding mount according to claim 1, wherein an arc-shaped mating groove is formed on the fixing portion.

6. The magnetic quick-release Bluetooth speaker riding mount according to claim 1, wherein the arc-shaped mating groove is formed on the fixing portion, and an inner side of the mating groove is provided with an anti-slip layer.

7. The magnetic quick-release Bluetooth speaker riding mount according to claim 1, wherein the arc-shaped mating groove is formed on the fixing portion, and an inner side surface of the mating groove is processed into a toothed surface.

8. The magnetic quick-release Bluetooth speaker riding mount according to claim 1, wherein the fixing portion comprises a flexible strap and a mounting platform disposed on the flexible strap for connection with the connecting portion, two ends of the flexible strap are provided with magnetic buckles; and when in use, the flexible strap is wrapped around and then secured by the magnetic buckles to form an annular fixing structure.

9. The magnetic quick-release Bluetooth speaker riding mount according to claim 1, wherein the connecting portion is an elastic clamp.

10. The magnetic quick-release Bluetooth speaker riding mount according to claim 1, wherein the connecting portion is a soft sleeve adapted to fit the Bluetooth speaker.
